(19) United States
(12) Patent Application Publication
(10) Pub. No.: US 2015/0111680 A1
(43) Pub. Date: Apr. 23, 2015

(54) Method and Device for Controlling and/or Regulating the Electromechanical Actuator of a Planetary Gear Assembly

(71) Applicants: Andreas KAPPEL, Brunnthal (DE); Johnson Controls GmbH, Burscheid (DE)

(72) Inventors: Ingo Kienke, Wermelskirchen (DE); Rolf Schüler, Heiligenhaus (DE); Christoph Schuhn, Dusseldorf (DE)

(73) Assignees: Andreas KAPPEL, Brunnthal (DE); Johnson Controls GmbH, Burscheid (DE)

(21) Appl. No.: 14/395,017

(22) PCT Filed: Apr. 19, 2013
(86) PCT No.: PCT/EP2013/058140

§ 371 Date: Oct. 16, 2014

(30) Foreign Application Priority Data
Apr. 20, 2012 (DE) 10 2012 007 759.9
Jul. 11, 2012 (DE) 10 2012 212 143.9

(51) Int. Cl. F16H 61/02; H02K 3/52; H02K 11/00; F16H 1/32

(52) U.S. Cl. CPC F16H 61/0251; F16H 1/32; H02K 3/522; H02K 11/0073
USPC 475/149

(57) ABSTRACT

A device for controlling and/or regulating the electromechanical actuator of a planetary gear assembly includes commutation electronics that are designed as an electronic circuit board and are arranged in a housing, directly on a solenoid ring of the electromechanical actuator. The housing accommodates the planetary gear assembly and the device that electromagnetically actuates the same. The solenoid ring is formed by annular solenoids that can be actuated in turn in the circumferential direction of the solenoid ring by the commutation electronics.

The invention relates to a device for open loop and/or closed loop controlling the electromechanical actuation of a planetary gear assembly. Furthermore, the invention relates to a method for open loop and/or closed loop controlling the electromechanical actuation of a planetary gear assembly and also a planetary gear assembly having a device for open loop and/or closed loop controlling the electromechanical actuation of said planetary gear assembly.

The prior art discloses a piezoelectric actuation of a planetary gear, in particular a wobble gear, also referred to as a Kappel motor.

An electromechanical actuating mechanism of a planetary gear comprises a stator ring having a plurality of electromagnets that are arranged around the circumference. Conventionally, it is necessary to control each electromagnet separately, which in the case of a number of conventionally 6 electromagnets leads to 12 individual supply lines. This renders the contacting process difficult and leads to large diameters of the supply lines and high costs.

It is known from DE 103 09 076 A1 to supply energy to multiple individual solenoids simultaneously.

The object of the present invention is to provide a method that is improved with respect to the prior art, and a device that is improved with respect to the prior art for open loop and/or closed loop controlling the electromechanical actuation of a planetary gear assembly and a planetary gear assembly having an improved device for open loop and/or closed loop controlling the electromechanical actuation of said planetary gear assembly.

With respect to the device for open loop and/or closed loop controlling the electromechanical actuation of a planetary gear assembly, the object is achieved by virtue of the features disclosed in claim 1.

With respect to the method for open loop and/or closed loop controlling the electromechanical actuation of a planetary gear assembly, the object is achieved by virtue of the features disclosed in claim 7.

With respect to the planetary gear assembly having a device for open loop and/or closed loop controlling the electromechanical actuation of a planetary gear assembly, the object is achieved by virtue of the features disclosed in claim 10.

Advantageous further developments of the invention are the subject of the subordinate claims.

The device for open loop and/or closed loop controlling the electromechanical actuation of a planetary gear assembly comprises in accordance with the invention a commutation electronic assembly that is embodied as an electronic circuit board and is arranged directly on an electromagnetic solenoid ring of the electromechanical actuating mechanism or is arranged within a housing that receives the planetary gear assembly and the means for electromechanical actuating said planetary gear assembly. The device in accordance with the invention significantly reduces the outlay regarding cabling and contacting the electromechanical actuating mechanism of a planetary gear assembly.

Furthermore, the requirements for a separate seat control device are simplified by virtue of using the integrated commutation electronic assembly.

Furthermore, the supply line diameter and the production costs are advantageously reduced.

In an expedient manner, the electromagnetic solenoid ring is formed from a plurality of electromagnetic solenoids that are arranged in an annular manner and can be activated alternately on a rotating basis in the circumferential direction of the electromagnetic solenoid ring by means of the commutation electronic assembly.

It is particularly preferred that the electromagnetic solenoids of the electromagnetic solenoid ring contact the electronic circuit board of the commutation electronic assembly directly, in particular without interpositioned lines. As a consequence, the process of contacting the electromagnetic solenoids in the electromagnetic solenoid ring is simplified and a length of the supply lines between the commutation electronic assembly and the electromagnetic solenoids is minimized as a result of said supply lines being arranged in a spatially tight manner.

It is particularly advantageous that the commutation electronic assembly is coupled to a bus system that preferably comprises three supply lines. In this manner, the number of supply lines for open loop and/or closed loop controlling the electromechanical actuation of a planetary gear assembly is significantly reduced.

In a first embodiment variant, the planetary gear assembly is embodied in an expedient manner as an individual open planetary gear.

In an alternative embodiment variant, the planetary gear assembly is embodied as a combination of multiple open planetary gears. As a consequence, it is possible to generate particularly high magnitudes of torque in the case by way of example of low rotational speeds. A drive unit that is formed from a planetary gear arrangement having a plurality of planetary gears is particularly compact and cost-effective.

In the case of the method for open loop and/or closed loop controlling the electromechanical actuation of a planetary gear assembly, the electromagnetic solenoids that are arranged in an annular manner in an electromagnetic solenoid ring are activated in accordance with the invention alternately on a rotating basis in the circumferential direction of the solenoid ring by means of the commutation electronic assembly, wherein the commutation electronic assembly is controlled by means of a bus system. In this manner, the number of supply lines for open loop and/or closed loop controlling the electromechanical actuation of a planetary gear assembly is significantly reduced.

In a first embodiment variant, each electromagnetic solenoid of the electromagnetic solenoid ring is open loop and/or closed loop controlled separately by means of the commutation electronic assembly. As a consequence, each electromagnetic solenoid can be open loop and/or closed loop controlled separately so that it is rendered possible to open loop and/or closed loop control the device in a delicate and efficient manner.

In a second embodiment variant, a plurality of electromagnetic solenoids of the electromagnetic solenoid ring are open loop and/or closed loop controlled jointly by means of the commutation electronic assembly. As a consequence, the process of electrically contacting the device for open loop and/or closed loop controlling the electromechanical actuation of a planetary gear assembly is further simplified.

The invention is explained in detail with reference to the attached schematic figures.

### IN THE DRAWINGS

FIG. 1 illustrates schematically a perspective view of an electromechanically actuated planetary gear assembly,

FIG. 2 illustrates schematically a perspective exploded view of an electromagnetic solenoid ring that is embodied as a stator ring having a retaining ring,

FIG. 3 illustrates schematically a perspective exploded view of an electromechanically actuated planetary gear assembly having a commutation electronic assembly,

FIG. 4 illustrates schematically a perspective view of a commutation electronic assembly that is embodied as an electronic circuit board,

FIG. 5 illustrates an internal construction and an internal interconnection of a commutation electronic assembly, and

FIG. 6 illustrates schematically a block diagram of a device for performing the method in accordance with the method.

Like parts are provided in all figures with like reference numerals.

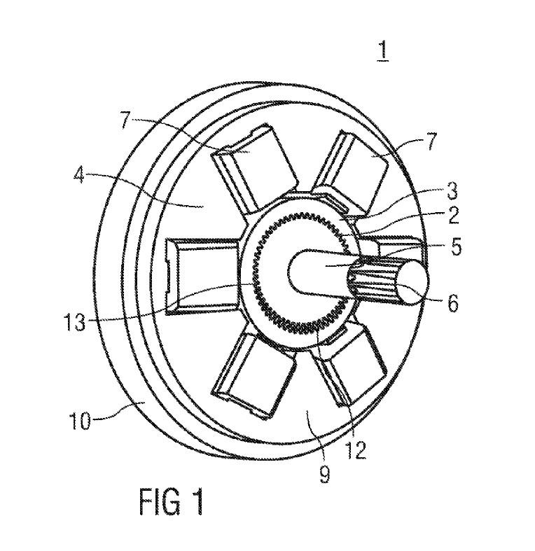

FIG. 1 illustrates schematically a perspective view of an electromechanically actuated planetary gear assembly 1. Such an electromechanically actuated planetary gear assembly 1 comprises at least one externally-toothed motor shaft gear wheel 2, an internally-toothed drive ring 3, a stator packet 4, a motor shaft 5 and a housing 10.

The planetary gear assembly 1 is preferably embodied as an individual open planetary gear, by way of example a wobble gear, or as a combination of multiple open planetary gears. An open planetary gear of this type is a simple planetary gear having only one central gear wheel and a non-coaxial rotating connecting shaft of a planetary gear wheel. The central gear wheel is by way of example in one possible embodiment formed from the outer, internally-toothed fitting, and the planetary gear wheel is formed by the inner, externally-toothed fitting of a seat adjusting mechanism, not illustrated.

The motor shaft 5 is embodied in the conventional manner as an eccentric shaft and comprises at one end preferably a drive pinion 6.

In embodiment variants, not illustrated, it is possible at one end of the motor shaft 5 to embody conventional fitting-key or wedge-shaft arrangements for the purpose of coupling to other components.

The stator packet 4 comprises a plurality of electromagnetic solenoids 7 that are arranged in an annular manner and are preferably embodied as electric solenoids and are encompassed by magnetic metal sheets 9.

In an alternative embodiment variant, the stator packet 4 is embodied as an electromagnetic solenoid ring 8.

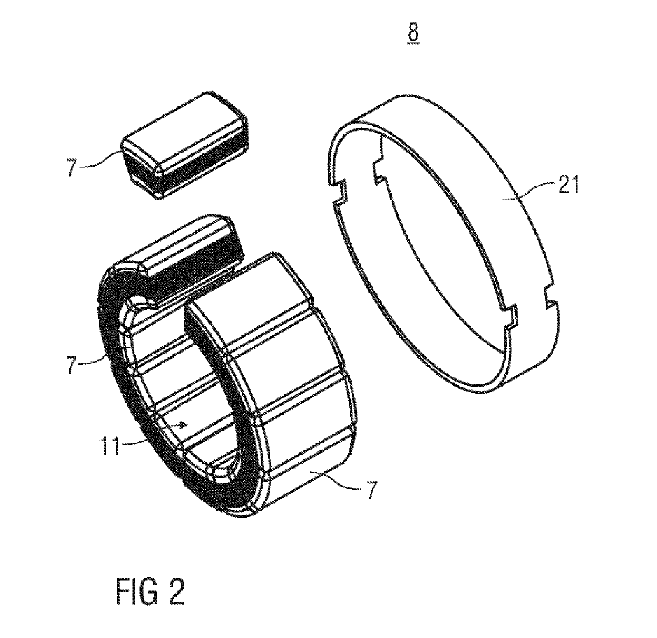

FIG. 2 illustrates schematically a perspective exploded view of an electromagnetic solenoid ring 8.

The electromagnetic solenoid ring 8 is preferably embodied from a plurality of electromagnetic solenoids 7 that are arranged in an annular manner and are held against one another and positioned by way of example by means of a retaining ring 21. An inner circumference 11 of the electromagnetic solenoid ring 8 is formed so as to correspond with the drive ring 3 and the movement of said drive ring, said movement being actuated by the electromagnetic solenoid ring 8.

If the electromagnetic solenoid ring 8 acts on the outer arranged, internally-toothed drive ring 3, then the electromagnetic solenoid ring 8 encompasses or surrounds the drive 3 on the outer side.

In one embodiment variant, not illustrated, the electromagnetic solenoid ring 8 can encompass the drive rings 3 of a multi-step gear motor.

In an alternative embodiment variant, not illustrated, the electromagnetic solenoid ring 8 acts on the inner arranged, externally-toothed motor shaft gear wheel 2, wherein the electromagnetic solenoid ring 8 is preferably at the end face on the planetary gear assembly 1.

In a further embodiment variant, not illustrated, the electromagnetic solenoid ring 8 can act on multiple externally-toothed motor shaft gear wheels 2 of a multi-step electromechanically actuated, open planetary gear 1.

In this embodiment variant, the gear steps of the electromechanically actuated planetary gear assembly 1 are not arranged as illustrated in FIG. 1 within the electromagnetic solenoid ring 8 but rather the gear steps are arranged in each case at the end face on the electromagnetic solenoid ring 8.

The internally-toothed drive ring 3 is arranged in a displaceable and non-rotatable manner in the electromagnetic solenoid ring 8. The externally-toothed motor shaft gear wheel 2 is arranged at least in part or by means of a section thereof in the internally-toothed drive ring 3 in such a manner that an external toothing 12 of the motor shaft gear wheel 2 can roll along an internal toothing 13 of the drive ring 3 in the conventional manner. The outer toothing 12 and the inner toothing 13 in the same module comprise teeth numbers that differ by at least one tooth, wherein the teeth number of the inner toothing 13 is greater than the teeth number of the outer toothing 12.

The motor shaft gear wheel 2 is arranged in a non-rotatably manner on the motor shaft 5 that for its part is arranged in a rotatable manner in the housing 10.

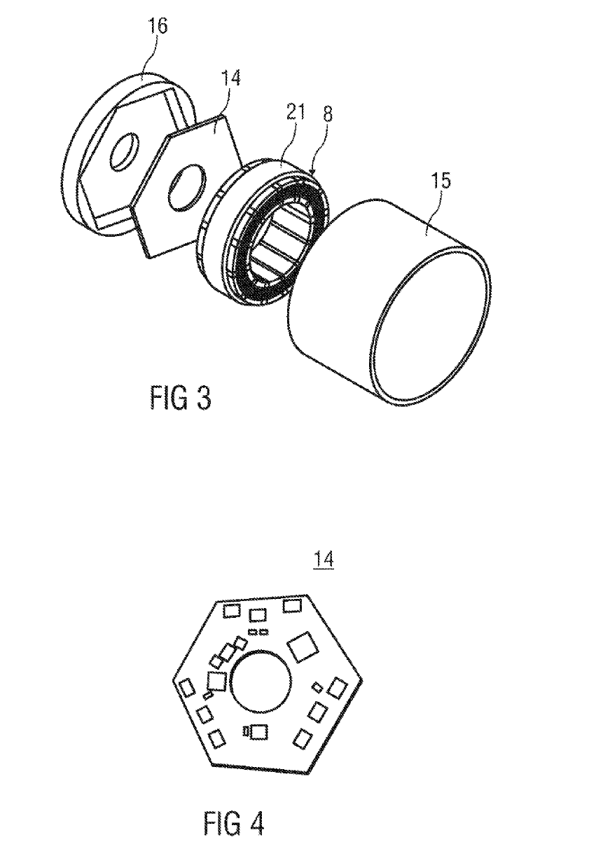

FIG. 3 illustrates schematically a perspective exploded view of the electromechanically actuated planetary gear assembly 1 having a commutation electronic assembly 14.

The commutation electronic assembly 14 is embodied as a conventional electronic circuit board. FIG. 4 illustrates schematically a perspective view of such a commutation electronic assembly 14 that is embodied as an electronic circuit board. The means for electromechanically actuating the planetary gear assembly 1, in particular the electromagnetic solenoid ring 8, are open loop and/or closed loop controlled by means of commutation electronic assembly 14.

In a particularly preferred embodiment variant, the electromagnetic solenoids 7 of the electromagnetic solenoid ring 8 contact directly the electronic circuit board of the commutation electronic assembly 14, in other words without interpositioned lines. The commutation electronic assembly 14 is arranged directly on the electromagnetic solenoid ring 8.

In a further preferred embodiment, the commutation electronic assembly 14 is arranged within the housing 10 that receives the planetary gear assembly 1 and the means for electromechanically actuating said planetary gear assembly 1 in the manner of a conventional electric motor.

In this manner, the process of contacting the electromagnetic solenoids 7 in the electromagnetic solenoid ring 8 is simplified and a length of the supply lines between the commutation electronic assembly 14 and the electromagnetic solenoids 7 is minimized as a result of said supply lines being arranged in a spatially tight manner.

In a first embodiment variant, each electromagnetic solenoid 7 is open loop and/or closed loop controlled separately by means of the commutation electronic assembly 14.

In an alternative embodiment variant, multiple electromagnetic solenoids 7, by way of example two, are open loop and/or closed loop controlled jointly by means of the electronic circuit board of the commutation electronic assembly 14.

The commutation electronic assembly 14 is controlled by means of a conventional bus system 17 that preferably comprises three supply lines. The bus system 17 is preferably embodied as a CAN (Controller Area Network) or a LIN (Local Interconnect Network) bus.

It is preferred that the housing 10 is embodied in the conventional manner to be preferably medium-tight and that said housing encompasses the components of the electromechanically actuated planetary gear assembly 1, in particular the electromagnetic solenoid ring 8 and the commutation electronic assembly 14. The housing 10 is preferably formed in two parts from a gear housing section 15 and a cover 16 that can be arranged at the end face on said gear housing section.

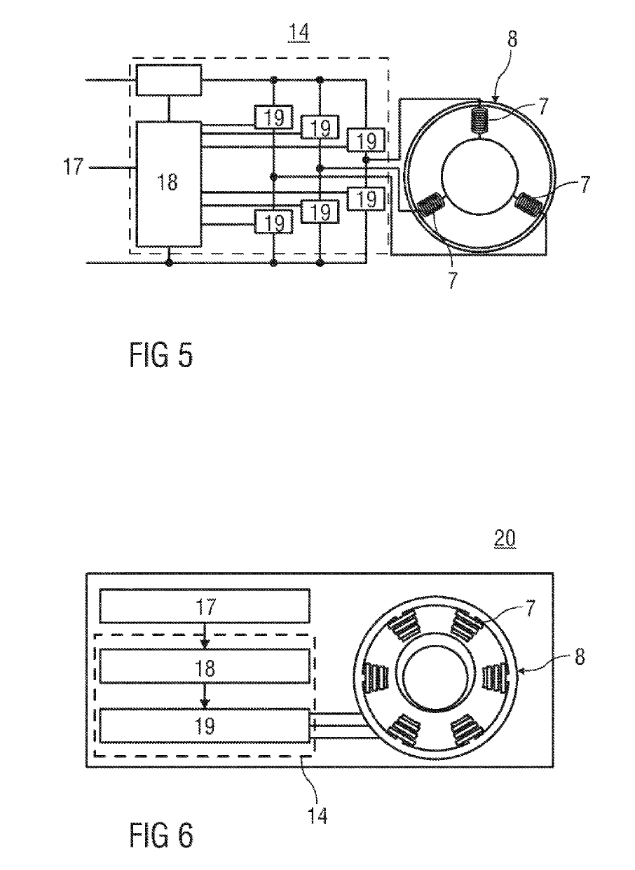

FIG. 5 illustrates schematically and by way of example an internal construction and an integral interconnection of the commutation electronic assembly 14.

The commutation electronic assembly 14 is embodied as a conventional control unit, in particular as an integrated control unit, within which the individual functions for open loop and/or closed loop controlling the electromechanical actuation of the planetary gear assembly 1 are performed as program sequences on a microprocessor 18.

The commutation electronic assembly 14 receives by means of the bus system 17 control signals, by way of example position details or travel routes and directions and said signals are converted by means of the commutation electronic assembly 14 into corresponding commutation signals for the electromagnetic solenoids 7 of the electromagnetic solenoid ring 8.

For this purpose, means for performing the method in accordance with the invention are integrated in the commutation electronic assembly 14, said means being for example open loop controlling, closed loop controlling, evaluating and/or analyzing modules, which are implemented as control programs and/or detection and analyzing programs.

In a manner not illustrated in detail, sensor signals by way of example position or location sensors can be supplied to the commutation electronic assembly 14 and said signals are processed by at least one of the modules for the purpose of generating control signals and/or output signals.

The position feedback is provided preferably by means of the pulse of the electromagnetic solenoids 7, which are evaluated by means of the commutation electronic assembly 14 so that it is not necessary to provide separate sensors.

The outputs of the microprocessor 18 for the purpose of controlling the electromagnetic solenoids 7 are allocated corresponding power semiconductors 19, by way of example power transistors, which amplify the output signals of the microprocessor 18 in the conventional manner and are electrically coupled to the electromagnetic solenoids 7.

A number of electromagnetic solenoids 7 in FIG. 5 is illustrated only as an example and in practice the number can be increased accordingly so that by way of example twelve electromagnetic solenoids 7 can be controlled by means of the commutation electronic assembly 14.

FIG. 6 illustrates schematically a block diagram of a device 20 for performing the method in accordance with the invention.

When performing the method in accordance with the invention, control signals are transmitted to the commutation electronic assembly 14 by means of the bus system 17. These control signals are converted within the commutation electronic assembly 14 by means of the microprocessor 18 into corresponding commutation signals for the electromagnetic solenoids 7 of the electromagnetic solenoid ring 8. The commutation signals are amplified by means of the power semiconductors 19 and forwarded to the electromagnetic solenoid 7.

These commutation signals are used to activate the electromagnetic solenoids 7 alternately on a rotating basis in the circumferential direction of the electromagnetic solenoid ring 8 so that the respective magnetic field of said electromagnetic solenoids acts on the internally-toothed drive ring 3 and causes said drive ring to move in a circular movement.

It is particularly preferred that the electromagnetic solenoids 7 that are adjacent in the circumferential direction of the electromagnetic ring 8 and overlapping are activated, which produces an improved torque curve. It is possible to activate multiple adjacent electromagnetic solenoids 7 simultaneously depending upon a level of efficiency and/or a torque curve.

The circular movement of the drive ring 3 and its inner-toothing 13 causes the outer toothing 12 of the motor shaft gear wheel 2 to roll along the inner toothing 13 of the drive ring 3 and as a result produces a rotational movement of the motor shaft gear wheel 2 and the motor shaft 5, which is coupled to said motor shaft gear wheel, and also a rotational movement of the drive pinion 6.

The device in accordance with the invention and the method significantly reduce the outlay regarding cabling and contacting the electromechanical actuating mechanism of a planetary gear assembly 1.

### LIST OF REFERENCE NUMERALS

1. Planetary Gear Assembly
2. Externally-toothed Motor Shaft Gear Wheel
3. Internally-toothed Drive Ring
4. Stator Packet
5. Motor Shaft
6. Drive Pinion
7. Electromagnetic Solenoid
8. Electromagnetic Solenoid Ring
9. Magnetic Metal Sheet
10. Housing
11. Inner Circumference
12. Outer Toothing
13. Inner Toothing
14. Commutation electronic assembly
15. Gear Housing Section
16. Cover
17 Bus System
18. Micro Processor
19. Power Semiconductor
20 Device
21. Retaining Ring

1. A device for open loop and/or closed loop controlling the electromechanical actuation of a planetary gear assembly, said device comprising:
a housing that receives a planetary gear assembly and a device for electromechanically actuating the planetary gear assembly;
an electromagnetic solenoid ring of the electromechanical actuation; and
a commutation electronic assembly that is embodied as an electronic circuit board and is arranged directly on the electromagnetic solenoid ring within the housing,
wherein the electromagnetic solenoid ring is formed from a plurality of electromagnetic solenoids that are arranged in an annular manner and can be activated alternately on a rotating basis in the circumferential direction of the electromagnetic solenoid ring by the commutation electronic assembly.

2. The device as claimed in claim 1, wherein the electromagnetic solenoids of the electromagnetic solenoid ring contact the electronic circuit board of the commutation electronic assembly directly.

3. The device as claimed in claim 1, wherein the commutation electronic assembly is coupled to a bus system.

4. The device as claimed in claim 3, wherein the bus system comprises three supply lines.

5. The device as claimed in claim 1, wherein the planetary gear assembly is embodied as an individual open planetary gear.

6. The device as claimed in claim 1, wherein the planetary gear assembly is embodied as a combination of multiple open planetary gears.

7. A method for open loop and/or closed loop controlling the electromechanical actuation of a planetary gear assembly, comprising:
activating the electromagnetic solenoids, which are arranged in an annular manner in an electromagnetic solenoid ring, alternately on a rotating basis in the circumferential direction of the electromagnetic solenoid ring by a commutation electronic assembly,
wherein the commutation electronic assembly is controlled by a bus system.

8. The method as claimed in claim 7, wherein each electromagnetic solenoid of the electromagnetic solenoid ring is open loop and/or closed loop controlled separately by the commutation electronic assembly.

9. The method as claimed in claim 7, wherein multiple electromagnetic solenoids of the electromagnetic solenoid ring are open loop and/or closed loop controlled jointly by the commutation electronic assembly.

10. A planetary gear assembly having a device for open loop and/or closed loop controlling the electromechanical actuation of said planetary gear assembly as claimed in claim 1.
